(19) United States
(12) Patent Application Publication
(10) Pub. No.: US 2025/0227662 A1
(43) Pub. Date: Jul. 10, 2025

(54) ON DEMAND PAGING FOR EXECUTING A PATH SWITCH IN SIDELINK RELAY

(71) Applicant: Telefonaktiebolaget LM Ericsson (publ), Stockholm (SE)

(72) Inventors: Antonino ORSINO, Kirkkonummi (FI); Yazid LYAZIDI, London, Greater London (GB); Liwei QUI, Täby (SE); Nithin SRINIVASAN, Köln (DE)

(21) Appl. No.: 18/702,637

(22) PCT Filed: Oct. 17, 2022
(86) PCT No.: PCT/EP2022/078814

§ 371 Date: Apr. 18, 2024

Related U.S. Application Data
(60) Provisional application No. 63/270,493, filed on Oct. 21, 2021.
(60) Provisional application No. 63/257,372, filed on Oct. 19, 2021.

(51) Int. Cl. H04W 68/00; H04W 36/00; H04W 76/14; H04W 76/27; H04W 88/04

(52) U.S. Cl. CPC H04W 68/00; H04W 36/033; H04W 76/14; H04W 76/27; H04W 88/04

(57) ABSTRACT

The invention refers to method and devices for on demand paging for executing a sidelink relay path switch, the method including: Receiving a message from a remote user equipment, UE, including a measurement report and a list of candidate relay UEs; Selecting a target relay UE for the sidelink relay path switch from the list of candidate relay UEs; and performing one of: Transmitting a paging request to an entity of a core network, CN, including instructions to page or instruct the target relay UE to transit to an RRC_CONNECTED state for sidelink relay path switch purposes; and Transmitting a paging request to the target relay UE, including a request or instructions to transit to an RRC_CONNECTED state for sidelink relay path switch purposes.

### TECHNICAL FIELD

The present disclosure relates generally to communications, and more particularly to communication methods and related devices and nodes supporting wireless communications.

### BACKGROUND

In current standardization of sidelink relay, the remote user equipment (UE) sends a measurement report to the network, together with the channel-related measurements, e.g., Reference Signal Received Strength (RSRP), Reference Signal Received Quality (RSRQ), Signal to Interference Noise Ratio (SINR), etc., the remote UE reports also a list of candidate relay UEs that is used by the 5G radio base station (gNB) in order to select a relay UE over which the remote UE may perform path switch. There currently exists certain challenge(s). A problem arises if the gNB picks from the list of relay UEs a relay UE in a Radio Resource Control (RRC), RRC_IDLE/INACTIVE state over which the remote UE is to perform path switch. In this case, the relay UE needs to first transit to the RRC_CONNECTED state and later receive an RRC reconfiguration message from the gNB in order to accommodate the remote UE and relay the remote UEs traffic to the gNB. However, the relay UE is unaware that it has been chosen by the gNB as a target relay UE and thus in this case is not possible to complete the path switch procedure as the gNB cannot send any direct signaling to the relay UE because the relay UE does not have any active RRC connection towards the gNB.

### SUMMARY

Certain aspects of the disclosure and their embodiments may provide solutions to these or other challenges. Certain aspects of the disclosure and their embodiments may provide solutions to these or other challenges. The exemplary embodiments described herein allow the gNB, the remote UE, or a core network (CN) to be able to page the relay UE chosen as a target relay UE for the sidelink relay path switch procedure. Upon receiving the measurement report from the remote UE and if a relay UE in RRC_IDLE/INACTIVE has been selected as the target relay UE by the gNB, at least one (or a combination) of the following solutions can be applied:
1. The gNB sends a message to at least one entity at the CN by indicating that the target relay UE chosen for the path switch needs to be paged in order to indicate that the target relay UE needs to transit to RRC_CONNECTED or the RRC_CONNECTED state.
   a) In this embodiment, the CN or entity of the CN may accept or reject the request sent by the gNB. If CN accepts, the CN may also indicate to the gNB that the paging message has been sent to the target relay UE. In another alternative, if the CN reject the request from the gNB, the CN may also indicate in the rejection whether the gNB needs to page the target relay UE or if the CN is simply not willing to do so. In this latter case the path switch procedure will fail.
   b) If the relay UE skips the paging (i.e., does not transit to RRC_CONNECTED), the gNB may eventually page another UE, or decide to select a target relay UE that is already in RRC_CONNECTED to speed up the path switch procedure. In another alternative, the gNB can send the path switch command, e.g., an RRC reconfiguration message, to the remote UE with an indication that the remote UE should establish a PC5 connection with the relay UE (if not available yet) and then indicate to the relay UE that the relay UE should transit to RRC_CONNECTED.
2. The gNB can decide to first page the target relay UE to indicate that the target relay UE needs to transit to RRC_CONNECTED.
   a) When doing this, the gNB may also indicate a paging cause to indicate to the relay UE that this paging is for sidelink relay path switch purposes
   b) If the relay UE skips the paging (i.e., does not transit to RRC_CONNECTED), the gNB may eventually page another UE, or decide to select a target relay UE that is already in RRC_CONNECTED to speed up the path switch procedure. Yet, in another alternative, the gNB can send the path switch command (i.e., an RRC reconfiguration message) to the remote UE with an indication that the remote UE should establish a PC5 connection with the relay UE (if not available yet) and then indicate to the relay UE that should transit to RRC_CONNECTED.
3. The gNB, instead of paging the candidate relay UE in RRC_IDLE/INACTIVE, the gNB sends the path switch command (i.e., an RRC reconfiguration message) to the remote UE with an indication that the remote UE should establish a PC5 connection with the relay UE (if not available yet) and then indicate to the relay UE that should transit to RRC_CONNECTED.
   a) In such a case the remote UE may report to the gNB if the relay UE has accepted or rejected to transit to RRC_CONNECTED to the gNB. If the relay UE has rejected to transit to RRC_CONNECTED, the gNB may select another relay UE or abort the path switch procedure. In another alternative, after reporting that the relay UE has rejected the request, the remote UE may trigger the RRC reestablishment procedure and relay (re)selection procedure.

Certain embodiments may provide one or more of the following technical advantage(s). When a candidate relay UE is selected as a target relay UE during the sidelink relay path switch procedure, the gNB, the remote UE, or the CN are able to page this UE and indicate that the UE should transit to RRC_CONNECTED in order to complete the sidelink relay path switch procedure. This will avoid that the path switch procedure is aborted when the target relay UE is in RRC_IDLE/INACTIVE. Additionally, the remote UE will not incur a long connectivity interruption due to the failed path switch procedure and the triggering of an RRC reestablishment procedure.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an example of a user plane stack for Layer 2 (L2) UE-to-Network Relay UE;

FIG. 2 is an example of a control plane for L2 UE-to-Network Relay UE;

FIG. 3 is a signal diagram of an example of connection establishment for indirect communication via UE-to-Network Relay UE;

FIG. 4 is a signal diagram illustrating an example of a procedure for remote UE switching to direct Uu cell;

FIG. 5 is a signal diagram of an example of a procedure for remote UE switching to indirect relay UE;

FIG. 6 is a signal diagram of an example of a procedure for target relay switching according to some embodiments of inventive concepts;

FIG. 7 is a flow chart of an example of a method for on demand paging for executing a sidelink relay path switch according to some embodiments of inventive concepts;

FIG. 8 is a table representing an example of contents of an initial UE message according to some embodiments of inventive concepts;

FIG. 9 is a signal diagram of an example of a paging request procedure according to some embodiments of inventive concepts;

FIG. 10 is a table representing an example of contents of a paging request according to some embodiments of inventive concepts;

FIG. 11 is a signal diagram of an example of a paging response procedure according to some embodiments of inventive concepts;

FIG. 12 is a table representing an example of contents of a sidelink (SL) relay paging request according to some embodiments of inventive concepts;

FIG. 13 is a table representing an example of contents of a SL relay paging response according to some embodiments of inventive concepts;

FIG. 14 is a flow chart of an example of a method for on demand paging for executing a sidelink relay path switch according to some embodiments of inventive concepts;

FIG. 15 is a flow chart of another example of a method for on demand paging for executing a sidelink relay path switch according to some embodiments of inventive concepts;

FIG. 16 is a block diagram illustrating a wireless device UE according to some embodiments of inventive concepts;

FIG. 17 is a block diagram illustrating a radio access network RAN node (e.g., a base station eNB/gNB) according to some embodiments of inventive concepts;

FIG. 18 is a block diagram illustrating a core network CN node (e.g., an AMF node, an SMF node, etc.) according to some embodiments of inventive concepts.

### DETAILED DESCRIPTION

Some of the embodiments contemplated herein will now be described more fully with reference to the accompanying drawings. Embodiments are provided by way of example to convey the scope of the subject matter to those skilled in the art., in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, certain embodiments may provide one or more of the following technical advantage(s). When a candidate relay UE is selected as a target relay UE during the sidelink relay path switch procedure, the gNB, the remote UE, or the CN are able to page this UE and indicate that the UE should transit to RRC_CONNECTED in order to complete the sidelink relay path switch procedure. This will avoid that the path switch procedure is aborted when the target relay UE is in RRC_IDLE/INACTIVE. Additionally, the remote UE will not incur a long connectivity interruption due to the failed path switch procedure and the triggering of an RRC reestablishment procedure.

### Sidelink Transmissions in New Radio (NR)

Sidelink transmissions over NR includes enhancements of the ProSe (PROximity-based SErvices) specified for Long-Term Evolution (LTE). Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of the Physical Sidelink Control Channel (PSCCH).
To achieve a high connection density, congestion control and thus the Quality of Service (QoS) management is supported in NR sidelink transmissions.

To enable the above enhancements, new physical channels and reference signals are introduced in NR (available in LTE before.):
Physical Sidelink Shared Channel (PSSCH), SL version of Physical Downlink Shared Channel (PDSCH): The PSSCH is transmitted by a sidelink transmitter UE, which conveys sidelink transmission data, system information blocks (SIBs) for radio resource control (RRC) configuration, and a part of the sidelink control information (SCI).
Physical Sidelink Feedback Channel (PSFCH), SL version of Physical Uplink Control Channel (PUCCH): The PSFCH is transmitted by a sidelink receiver UE for unicast and groupcast, which conveys 1 bit information over 1 RB for the Hybrid Automatic Repeat Request (HARQ) acknowledgement (ACK) and the negative ACK (NACK). In addition, channel state information (CSI) is carried in the medium access control (MAC) control element (CE) over the PSSCH instead of the PSFCH.
Physical Sidelink Common Control Channel (PSCCH), SL version of Physical Downlink Control Channel (PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured bandwidth parts (BWP). The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature is the two-stage sidelink control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as an 8-bits source identity (ID) and a 16-bits destination ID, NDI, RV and HARQ process ID is sent on the PSSCH to be decoded by the receiver UE.

Similar as for PROSE in LTE, NR sidelink transmissions have the following two modes of resource allocations:
Mode 1: Sidelink resources are scheduled by a gNB.
Mode 2: The UE autonomously selects sidelink resources from a (pre-)configured sidelink resource pool(s) based on the channel sensing mechanism.

For the in-coverage UE, a gNB can be configured to adopt Mode 1 or Mode 2. For the out-of-coverage UE, only Mode 2 can be adopted. As in LTE, scheduling over the sidelink in NR is done in different ways for Mode 1 and Mode 2. Mode 1 supports the following two kinds of grants:
Dynamic grant: When the traffic to be sent over sidelink arrives at a transmitter UE, this UE should launch the four-message exchange procedure to request sidelink resources from a gNB (SR on UL, grant, BSR on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI. When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

### Discovery Procedures

There are device-to-device (D2D) discovery procedures for detection of services and applications offered by other UEs in close proximity. The discovery procedure has two modes, mode A based on open announcements (broadcasts) and mode B, which is request/response. The discovery mechanism is controlled by the application layer, e.g. the ProSe layer. In NR the discovery message is sent on the PSSCH. The discovery procedure can be used to detect UEs supporting certain services or applications before initiating the communication. Both dedicated discovery resource pool (i.e., only discovery message can be transmitted in the pool) and shared resource pool configuration (i.e., both discovery message and other data&control message can be transmitted in the pool) are supported in NR, whether dedicated discovery resource pool is configured is based on network implementation.

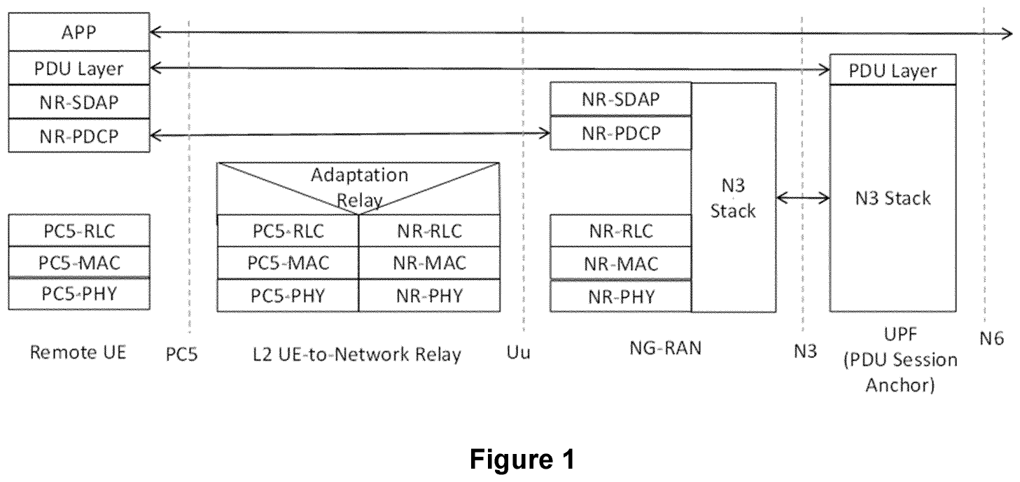

FIG. 1 is an example of a user plane stack for Layer 2 (L2) UE-to-Network Relay UE. The protocol architecture supporting a L2 UE-to-Network Relay UE is provided. The L2 UE-to-Network Relay UE provides forwarding functionality that can relay any type of traffic over the PC5 link. The L2 UE-to-Network Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage. FIG. 1 illustrates the protocol stack for the user plane transport, related to a PDU Session, including a Layer 2 UE-to-Network Relay UE. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the Packet Data Convergence Protocol (PDCP) link are the Remote UE and the gNB. The relay function is performed below PDCP. This means that data security is ensured between the Remote UE and the gNB without exposing raw data at the UE-to-Network Relay UE.

The adaptation rely layer within the UE-to-Network Relay UE can differentiate between signaling radio bearers (SRBs) and data radio bearers (DRBs) for a particular Remote UE. The adaption relay layer is also responsible for mapping PC5 traffic to one or more DRBs of the Uu. The definition of the adaptation relay layer is under the responsibility of RAN WG2.

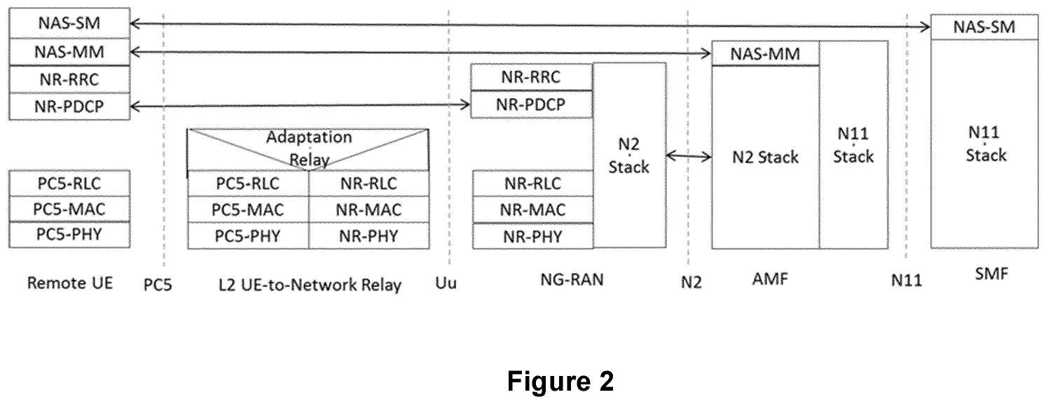

FIG. 2 illustrates the protocol stack of the non-access stratum (NAS) connection for the Remote UE to the NAS-MM and NAS-SM components. The NAS messages are transparently transferred between the Remote UE and 5G-AN over the Layer 2 UE-to-Network Relay UE using:
PDCP end-to-end connection where the role of the UE-to-Network Relay UE is to relay the PDUs over the signaling radio bear without any modifications.
N2 connection between the 5G-AN and AMF over N2.
N3 connection AMF and SMF over N11.

The role of the UE-to-Network Relay UE is to relay the PDUs from the signaling radio bearer without any modifications.

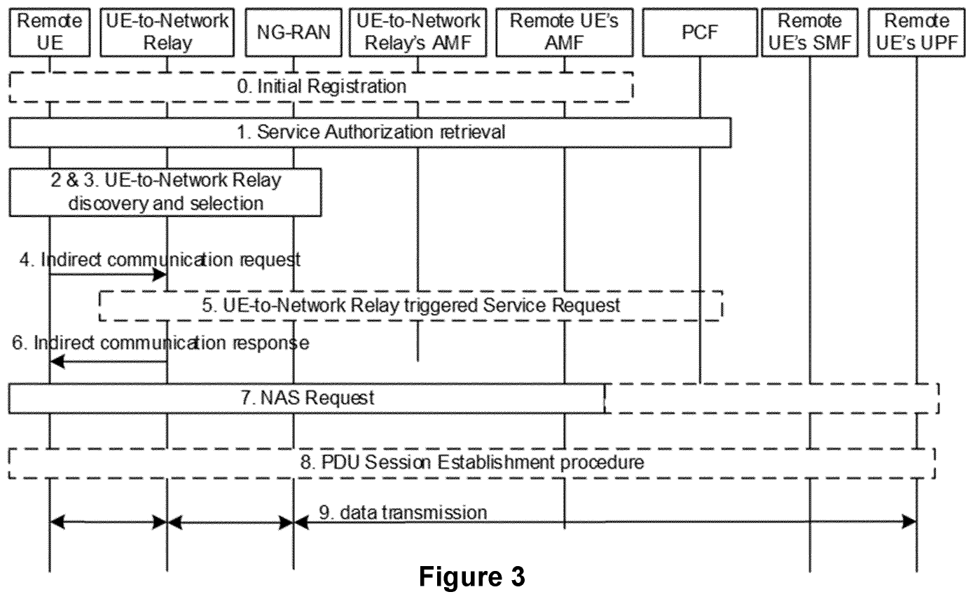

FIG. 3 is a signal diagram of an example of connection establishment procedure for indirect communication via UE-to-Network Relay UE. The procedure includes:
0. If in coverage, the Remote UE and UE-to-Network Relay UE may independently perform the initial registration to the network. The allocated 5G GUTI of the Remote UE is maintained when later NAS signaling between Remote UE and Network is exchanged via the UE-to-Network Relay UE.

NOTE: The current procedures shown here assume a single hop relay.
1. If in coverage, the Remote UE and UE-to-Network Relay UE independently get the service authorization for indirect communication from the network.
2-3. The Remote UE and UE-to-Network Relay UE perform UE-to-Network Relay UE discovery and selection.
4. Remote UE initiates a one-to-one communication connection with the selected UE-to-Network Relay UE over PC5, by sending an indirect communication request message to the UE-to-Network Relay.
5. If the UE-to-Network Relay UE is in CM_IDLE state, triggered by the communication request received from the Remote UE, the UE-to-Network Relay UE sends a Service Request message over PC5 to its serving AMF.

The Relay's AMF may perform authentication of the UE-to-Network Relay UE based on NAS message validation and if needed the AMF will check the subscription data.

If the UE-to-Network Relay UE is already in CM_CONNECTED state and is authorized to perform Relay service then step 5 is omitted.
6. The UE-to-Network Relay UE sends the indirect communication response message to the Remote UE.
7. Remote UE sends a NAS message to the serving AMF. The NAS message is encapsulated in an RRC message that is sent over PC5 to the UE-to-Network Relay UE, and the UE-to-Network Relay UE forwards the message to the NG-RAN. The NG-RAN derives Remote UE's serving AMF and forwards the NAS message to this AMF.

NOTE: It is assumed that the Remote UE's PLMN is accessible by the UE-to-Network Relay's PLMN and that UE-to-Network Relay UE AMF supports all S-NSSAIs the Remote UE may want to connect to.

If Remote UE has not performed the initial registration to the network in step 0, the NAS message is initial registration message. Otherwise, the NAS message is service request message.

If the Remote UE performs initial registration via the UE-to-Network relay, the Remote UE's serving AMF may perform authentication of the Remote UE based on NAS message validation and if needed the Remote UE's AMF checks the subscription data.

For service request case, User Plane connection for PDU Sessions can also be activated.
8. Remote UE may trigger the PDU Session Establishment procedure.
9. The data is transmitted between Remote UE and UPF via UE-to-Network Relay UE and NG-RAN. The UE-to-Network Relay UE forwards all the data messages between the Remote UE and NG-RAN using RAN specified L2 relay method.

L2 UE-to-Network Relay uses the RAN2 principle of the Rel-15 NR handover procedure as the baseline AS layer solution to guarantee service continuity, i.e., gNB hands over the Remote UE to a target cell or target Relay UE, including:
1) Handover preparation type of procedure between gNB and Relay UE (if needed);
2) RRCReconfiguration to Remote UE, Remote UE switching to the target, and
3) Handover complete message, similar to the legacy procedure.

### Switching from Indirect to Direct Path

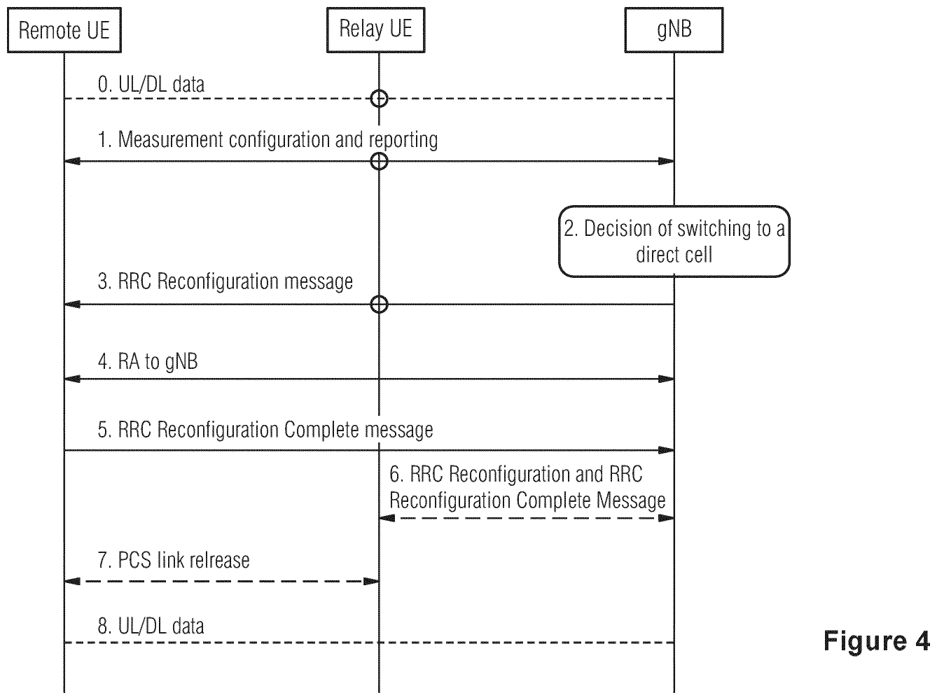

FIG. 4 is a signal diagram illustrating an example of a procedure for remote UE switching to direct Uu cell. For service continuity of L2 UE-to-Network relay, the following baseline procedure illustrated in FIG. 4 is used, in case of Remote UE switching to direct Uu cell.
Step 1: Measurement configuration and reporting
Step 2: Decision of switching to a direct cell by gNB
Step 3: RRC Reconfiguration message to Remote UE
Step 4: Remote UE performs Random Access to the gNB
Step 5: Remote UE feedback the RRCReconfigurationComplete to gNB via target path, using the target configuration provided in the RRC Reconfiguration message.
Step 6: RRC Reconfiguration to Relay UE
Step 7: The PC5 link is released between Remote UE and the Relay UE, if needed.
Step 8: The data path switching.

NOTE: The order of step 6/7/8 is not restricted. Following are further discussed in WI phase, including:
Whether Remote UE suspends data transmission via relay link after step 3;
Whether Step 6 can be before or after step 3 and its necessity;
Whether Step 7 can be after step 3 or step 5, and its necessity/replaced by PC5 reconfiguration;
Whether Step 8 can be after step 5.

### Switching from Direct to Indirect Path

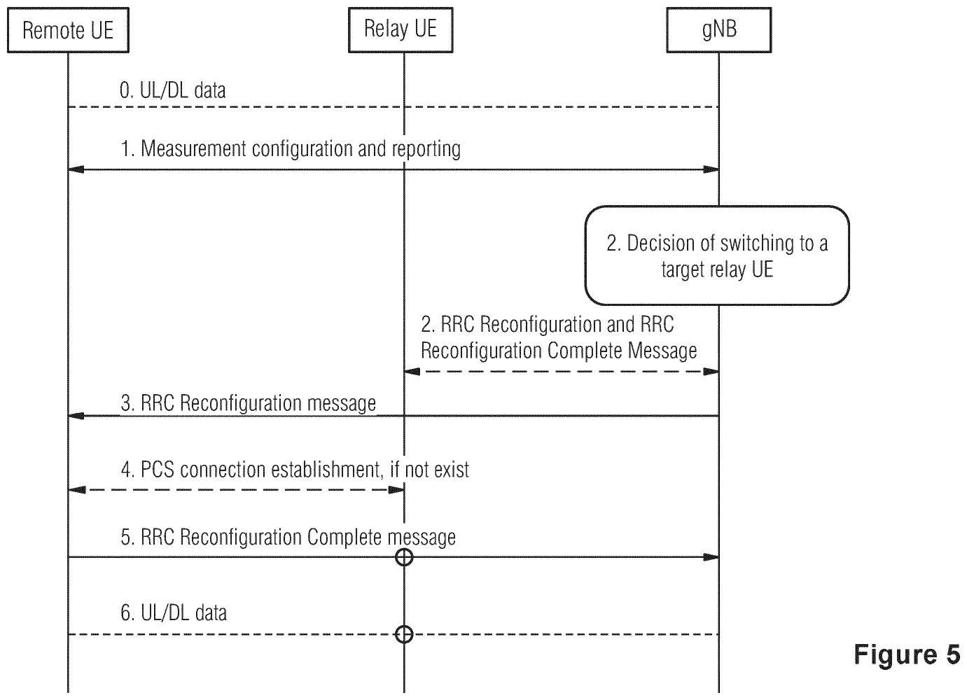

FIG. 5 is a signal diagram of an example of a procedure for remote UE switching to indirect relay UE. For service continuity of L2 UE-to-Network Relay, the following baseline procedure illustrated in FIG. 5 is used, in case of Remote UE switching to indirect Relay UE:
Step 1: Remote UE reports one or multiple candidate Relay UE(s), after Remote UE measures/discoveries the candidate Relay UE(s).
   Remote UE may filter the appropriate Relay UE(s) meeting higher layer criteria when reporting, in step 1.
   The reporting may include the Relay UE's ID and SL RSRP information, where the measurement on PC5 details can be left to WI phase, in step 1.
Step 2: Decision of switching to a target Relay UE by gNB, and target (re) configuration is sent to Relay UE optionally (like preparation).
Step 3: RRC Reconfiguration message to Remote UE. Following information may be included: 1) Identity of the target Relay UE; 2) Target Uu and PC5 configuration.
Step 4: Remote UE establishes PC5 connection with target Relay UE, if the connection has not been setup yet.
Step 5: Remote UE feedback the RRCReconfigurationComplete to gNB via target path, using the target configuration provided in RRCReconfiguration.
Step 6: The data path switching.
NOTE: Following are further discussed in WI phase, including:
   Whether Step 2 should be after Relay UE connects to the gNB (e.g., after step 4), if not yet before;
   Whether Step 4 can be before step 2/3.

The methods and solutions described herein allowing the gNB, the remote UE, or the core network (CN) to be able to page the relay UE chosen as target relay UE for the sidelink relay path switch procedure. In order to do so, upon receiving the measurement report from the remote UE and if a relay UE in RRC_IDLE/INACTIVE has been selected as target relay UE by the gNB, at least one (or a combination) of the following solutions can be applied:
1. The gNB sends a message to at least one entity at the CN by indicating that the target relay UE chosen for the path switch needs to be paged in order to indicate that needs to transit to RRC_CONNECTED.
   a) In this case, the CN may accept or reject the request sent by the gNB. In case the CN accept, the CN may also indicate to the gNB that the paging message has been sent to the target relay UE. Yet, in another alternative, if the CN reject the request from the gNB it may also indicate in the reject on whether is the gNB itself that needs to page the target relay UE or if the CN is simply not willing to do so (in this latter case the path switch procedure will fail).
   b) If the relay UE skips the paging (i.e., does not transit to RRC_CONNECTED), the gNB may eventually page another UE, or decide to select a target relay UE that is already in RRC_CONNECTED to speed up the path switch procedure. Yet, in another alternative, the gNB can send the path switch command (i.e., an RRC reconfiguration message) to the remote UE with an indication that the remote UE should establish a PC5 connection with the relay UE (if not available yet) and then indicate to the relay UE that should transit to RRC_CONNECTED.
2. The gNB can decide to first page the target relay UE to indicate that needs to transit to RRC_CONNECTED.
   a) When doing this, the gNB may also indicate a paging cause to indicate to the relay UE that this paging is for sidelink relay path switch purposes
   b) If the relay UE skips the paging (i.e., does not transit to RRC_CONNECTED), the gNB may eventually page another UE, or decide to select a target relay UE that is already in RRC_CONNECTED to speed up the path switch procedure. Yet, in another alternative, the gNB can send the path switch command (i.e., an RRC reconfiguration message) to the remote UE with an indication that the remote UE should establish a PC5 connection with the relay UE (if not available yet) and then indicate to the relay UE that should transit to RRC_CONNECTED.
3. The gNB, instead of paging itself the candidate relay UE in RRC_IDLE/INACTIVE, it sends the path switch command (i.e., an RRC reconfiguration message) to the remote UE with an indication that the remote UE should establish a PC5 connection with the relay UE (if not available yet) and then indicate to the relay UE that should transit to RRC_CONNECTED.
   a) In such a case the remote UE may report to the gNB if the relay UE has accepted or rejected to transit to RRC_CONNECTED to the gNB. Then the gNB may decide to select another relay UE or simply abort the path switch procedure. Yet, in another alternative, after reporting that the relay UE has rejected the request, the remote UE may trigger the RRC reestablishment procedure and relay (re)selection procedure.

The embodiments are described in the context of NR, i.e., remote UE and relay UE are deployed in a same or different NR cell. The embodiments are also applicable to other relay scenarios including UE to network relay or UE to UE relay where the remote UE and the relay UE may be based on LTE sidelink or NR sidelink, the Uu connection between the relay UE and the base station may be LTE Uu or NR Uu.

The terms “direct connection” or “direct path” are used to stand for a connection between a UE and a gNB, while the terms “indirect connection” or “indirect path” are used to stand for a connection between a remote UE and gNB via a relay UE. In addition, the term “path switch” is used when the remote UE changes between a direct path (i.e., Uu connection) and an indirect path (i.e., relay connection via a SL relay UE). The other term such as “relay selection/reselection” is equally applicable here without losing any meaning.

In the following embodiments, the scenario considered is when the remote UE sends a measurement report to the gNB with a list of candidate relay UEs in which RRC status can be either RRC_CONNECTED, RRC_IDLE, or RRC_INACTIVE. The embodiments described herein consider the use case when a relay UE in RRC_IDLE or RRC_INACTIVE is selected by the gNB as the target relay UE for the path switch procedure. The remote UE when reporting the list of candidate relay UEs to the gNB, the remote UE also reports for each relay UE in the list also a respective ID that can be used by the gNB, CN, or remote UE to perform paging (or send some control plane signaling) to the relay UE.

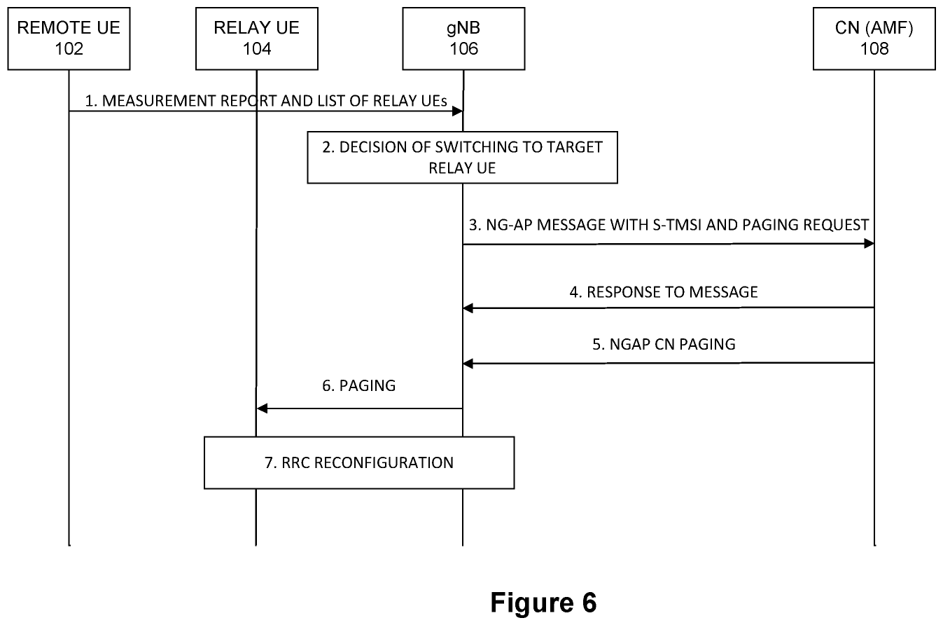

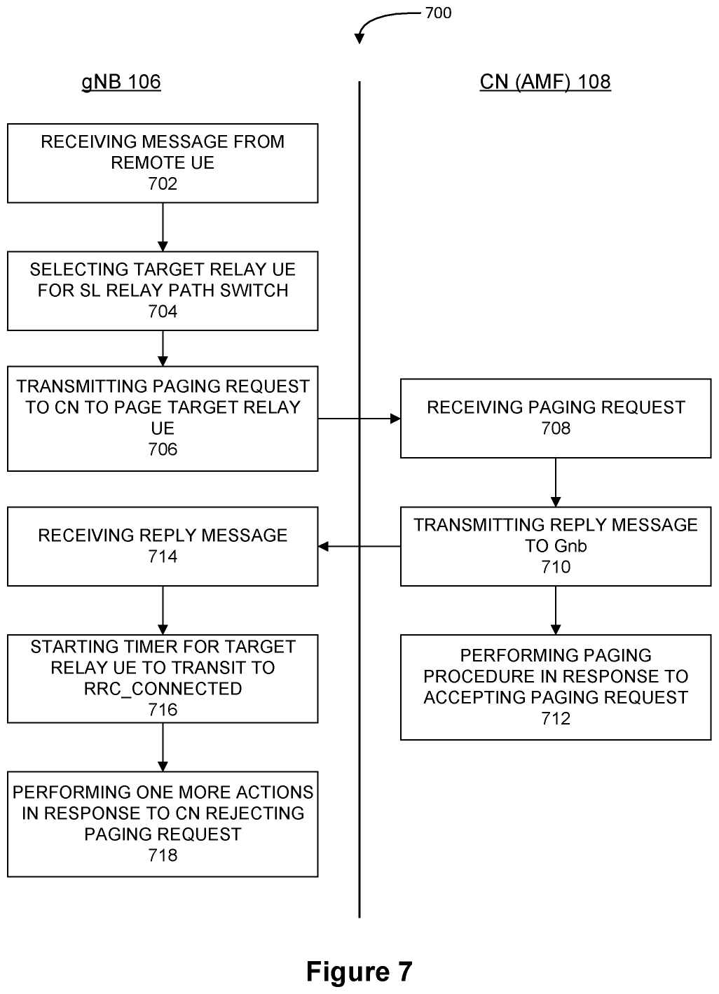

FIG. 6 is a signal diagram of an example of a procedure for target relay switching according to some embodiments of inventive concepts. Examples of different methods for on demand paging for executing a sidelink relay path switch corresponding to FIG. 6 will be described with reference to FIGS. 7, 14, and 15. In step 1 of FIG. 6, a gNB 106 receives a measurement report from a remote UE 102 with a list of candidate UEs. The gNB 106 may also be referred to herein as a network node. In step 2, a decision of switching to a target relay UE is made and a target relay UE is selected from the list of candidate UEs.

In step 3, a NG Application Protocol (NG-AP) message with SAE-Temporary Mobile Subscriber Identity (S-TMSI) and a paging request is transmitted to the CN 108 or at least one entity of the CN 108. In the example in FIG. 6 an Access and Mobile Management Function (AMF) node of the CN 108 receives the message.

In step 4, the CN 108 or entity of the CN 108 transmits a response message to the gNB 106 indicating whether the CN 108 accepted or rejected the paging request. If the CN 108 accepted the paging request, in step 5, the CN 108 or entity performs the paging procedure. In step 5, the CN 108 transmits a NG-AP paging message to the gNB 106 and in step 6, the paging message is forwarded by the gNB 106 to the target relay UE 104 to request or instruct the target relay UE to transit to an RRC_CONNECTED state for sidelink relay path switch purposes. As described with reference to at least FIG. 7, if the CN 108 rejects the paging request, the gNB 106 performs one or more actions in response to the CN 108 or entity rejecting the paging request.

In step 7, RRC reconfiguration is performed by the relay UE transiting to the RRC_CONNECTED state for serving as a sidelink relay path switch for the remote UE 102.

FIG. 7 is a flow chart of an example of a method 700 for on demand paging for executing a sidelink relay path switch according to some embodiments of inventive concepts. In block 702, the method 700 includes receiving, by a network node, a message from a remote user equipment (UE). The message includes a measurement report and a list of candidate relay UEs.

In block 704, the method 700 includes selecting, by the network node, a target relay UE for the sidelink relay path switch from the list of candidate relay UEs.

In block 706, the method 700 includes transmitting, by the network node, a paging request to an entity of a core network (CN). The paging request includes a request or instructions for the entity of the CN to page or instruct the target relay UE to transit to an RRC_CONNECTED state for sidelink relay path switch purposes. In some examples, transmitting the paging request includes transmitting an NG-AP request message with a (Serving Temporary Mobile Subscriber Identity (S-TMSI) and the paging request. The NG-AP request message includes one of:
an existing message from Technical Standard (TS) 38.413, e.g., INITIAL UE MESSAGE;
a new class 1 (request and response) or class 2 (request only) procedure;
a S-TMSI of the target relay UE, optionally or any ID that can allow an Access & Mobility Management Function (AMF) to authenticate the request message.

Upon receiving a measurement report from a remote UE with a list of candidate relay UE(s), if the gNB selects as target relay UE a relay UE that is in RRC_IDLE or RRC_INACTIVE, the gNB sends a message to at least one entity at the CN in order to indicate that the target relay UE chosen for the sidelink relay path switch needs to be paged to indicate to the relay UE that the target relay UE needs to transit to RRC_CONNECTED for sidelink relay path switch purposes.

When the gNB sends a message to at least one entity at the CN in order to indicate that the target relay UE chosen for the sidelink relay path switch needs to be paged so to indicate to the relay UE that it needs to transit to RRC_CONNECTED for sidelink relay path switch purposes, the gNB may include one (or a combination) of the following information:
The ID(s) of the relay UE (e.g., the UE-TMSI, RNTI, or any other ID useful to identify the relay UE at the CN).
The L2 ID of the relay UE (or any other ID used by the relay UE for sidelink purposes).
The ID(s) of the remote UE (e.g., the UE-TMSI, RNTI, or any other ID useful to identify the relay UE at the CN).
The L2 ID of the remote UE (or any other ID used by the relay UE for sidelink purposes).
A paging cause.
A UE context ID of the relay UE.
A UE context ID of the remote UE.

In block 708, the method 700 includes receiving the paging request by the CN 108 or entity. In block 710, the method 700 includes transmitting the reply message to the gNB 106. In block 712, the method 700 includes performing the paging procedure by the CN 108 or entity in response to accepting the paging request.

Upon receiving the message or paging request from the gNB to page a certain target relay UE for sidelink relay path switch purposes, the CN (e.g., the entity at the CN that received this message) may reply to the gNB on whether the CN agreed to page the target relay UE or reject the gNB request. Whether the CN accepts or reject the gNB request, the CN may indicate this to the gNB. If the CN 108 or entity accepts the gNB request, the CN starts the CN-initiated paging procedure in order to page the target relay UE. When sending the paging to the target relay UE 104, the CN 106 may include a paging cause in the paging message in order to indicate to the relay UE 104 that this paging message is for sidelink relay path switch purposes. The CN may eventually send a message to the gNB 106 for informing the gNB 106 that the paging message has been sent and the gNB 106 may start a timer. If the timer expires and the relay UE has not transited to RRC_CONNECTED, the gNB 106 determines that the relay UE is not willing to accommodate the remote UE and the gNB may perform further actions.

In block 714, the method 700 includes receiving, by the gNB 106, a reply message from the CN 108 entity of the CN 108. The reply message indicates that the CN 108 or entity accepted the paging request to page the target relay EU 104, or the CN 108 rejects the paging request.

In block 716, the method 700 includes starting a timer for the target relay to transit to the RRC_CONNECTED state before expiration of the timer in response to the reply message indicating the CN accepted the paging request.

In block 718, the method 700 includes performing one or more of a set of actions in response to the entity of the CN rejecting the paging request. In some examples, the set of actions include:
aborting path switch procedure and release the remote UE to RRC_IDLE or RRC_INACTIVE;
selecting a new target relay UE from the list of candidate relay UEs received from the remote UE, whatever the RRC state of the relay UE in the list is;
selecting a new target relay UE from the list of candidate relay UEs but only among those relay UEs which are in RRC_CONNECTED state;
sending a message to the remote UE for informing that the target relay UE is not available and that a new list of candidate relay UEs needs to be produced by the remote UE and then send to the network node; and
starting the paging (gNB-initiated paging) procedure towards the relay UE, if instructed by the CN to do so.

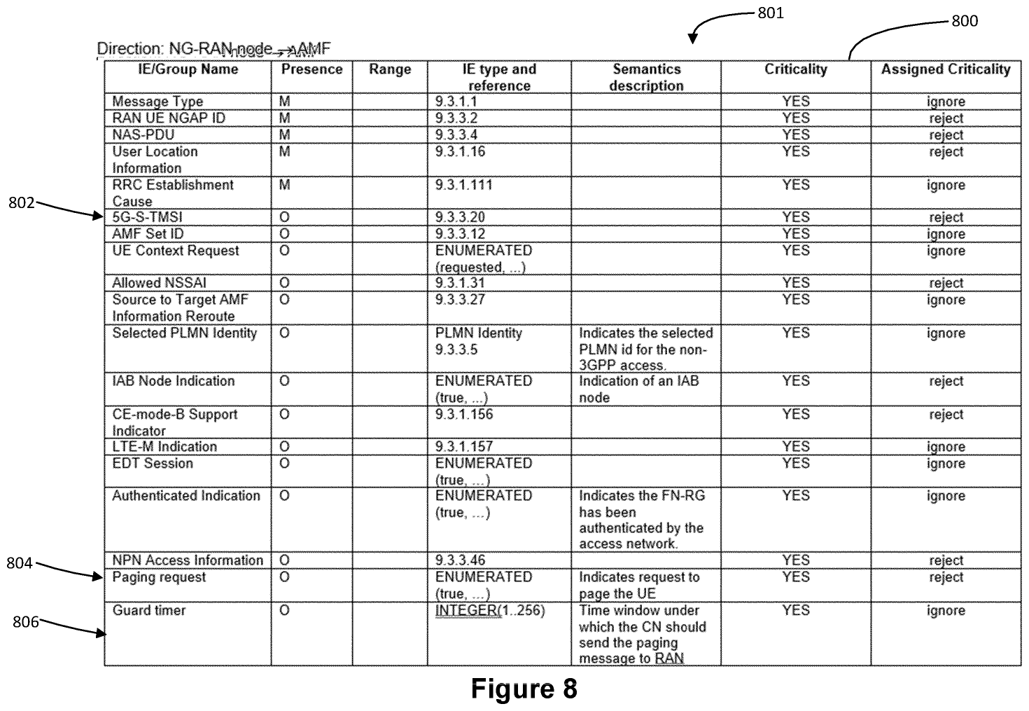

Transmitting the paging request in block 706 corresponds to step 3 in FIG. 6. In an embodiment, the gNB 106 upon selecting and deciding the relay UE 104 to switch the direct path to (step 2 in FIG. 6), the gNB 106 sends a NG-AP request message to the 5G CN 106 (AMF) with the S-TMSI of the selected Relay UE and a request for paging. In an embodiment, the NG-AP message in step 3 of FIG. 6 can be an existing message, e.g., INITIAL UE MESSAGE. In another embodiment, the NG-AP message in step 3 can be a new class 1 (request and response) or class 2 (request only) procedure. In one embodiment, the message in step 3 includes the S-TMSI of the relay UE, optionally or any ID that can allow the CN 106 or AMF to authenticate the message, a paging request, as well as a time window under which the CN 106 should send the CN Paging message to a RAN. FIG. 8 an example of possible enhancement to a message to support step 3 described above. FIG. 8 is a table 800 representing an example of contents of an initial UE message 801 according to some embodiments of inventive concepts. The enhancements include a 5G-TSMI 802, a paging request 804 and a guard timer 806. In some examples, the message 801 is sent by the NG-RAN node to transfer the initial layer 3 message to the AMF over the NG interface.

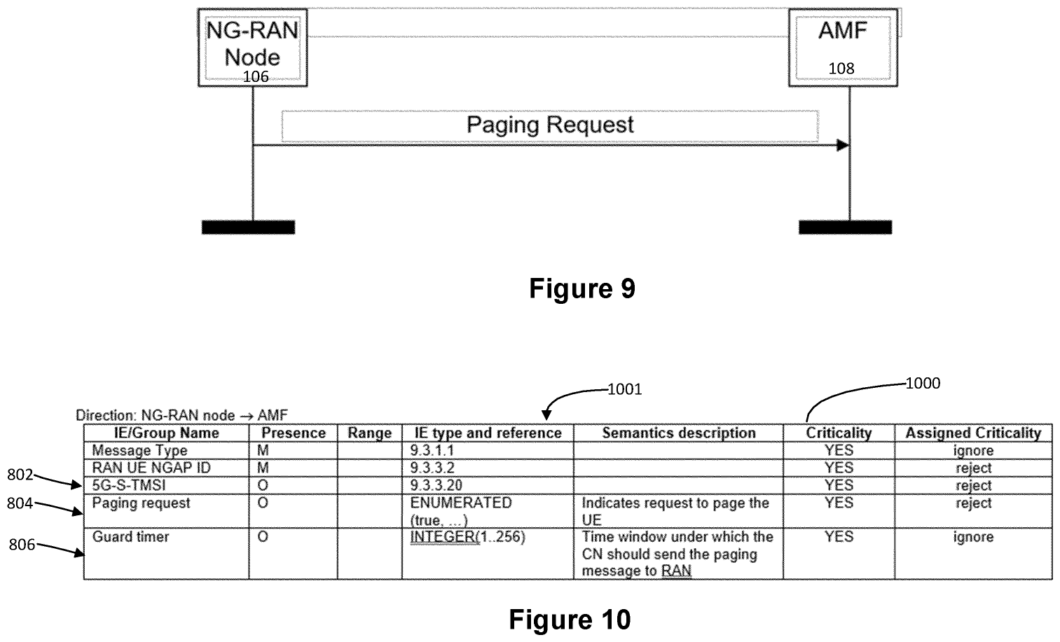

FIG. 9 is a signal diagram of an example of a paging request procedure according to some embodiments of inventive concepts. FIG. 9 is an example of a new class 2 procedure that can be used for step 3 in FIG. 6 or block 706 in FIG. 7.

FIG. 10 is a table 1000 representing an example of contents of a paging request 1001 in FIG. 9 according to some embodiments of inventive concepts. The paging request include a 5G-S-TMSI 802, Paging Request 804, and a Guard Timer 806. In some examples, the message or paging request 1001 is sent by the NG-RAN node to request the AMF paging a specific UE over the NG interface.

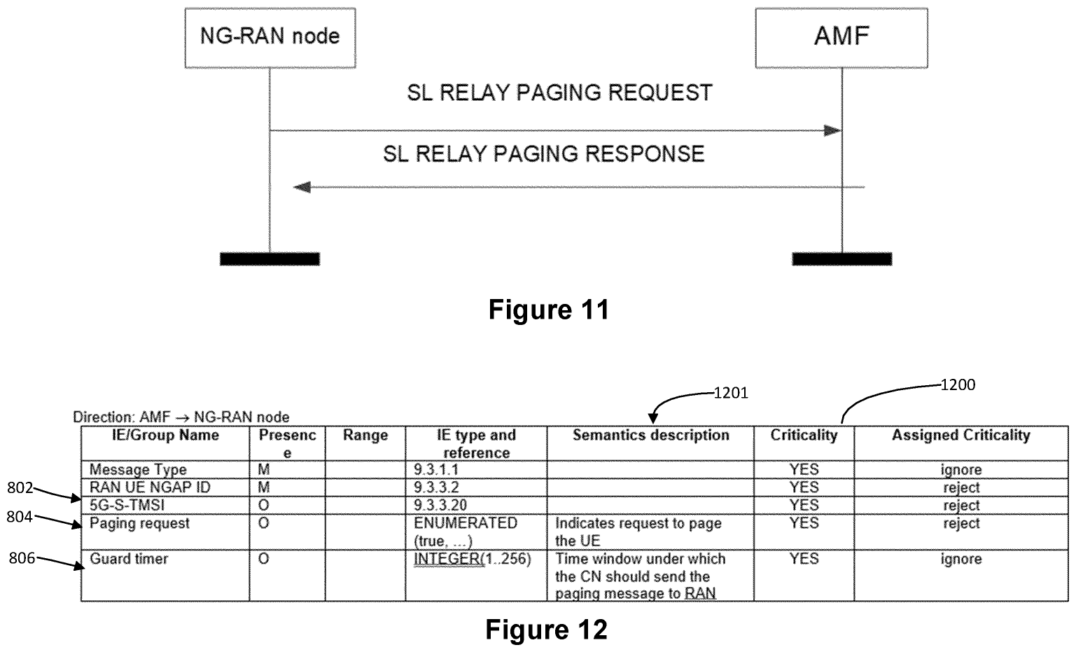

FIG. 11 is a signal diagram of an example of a paging response procedure according to some embodiments of inventive concepts. The paging response procedure incudes a SL relay paging request sent form a NG-RAN node to a AMF and a SL relay paging response sent from the AMF to the NG-RAN node.

FIG. 12 is a table 1200 representing an example of contents of a sidelink (SL) relay paging request 1201 according to some embodiments of inventive concepts. The SL relay paging request 1201 in the example in FIG. 12 includes a 5G-S-TSMI 802, a paging request 804, and a guard timer 806. In the example in FIG. 11, the message is sent by the NG-RAN node to request the AMF paging a specific UE over the NG interface.

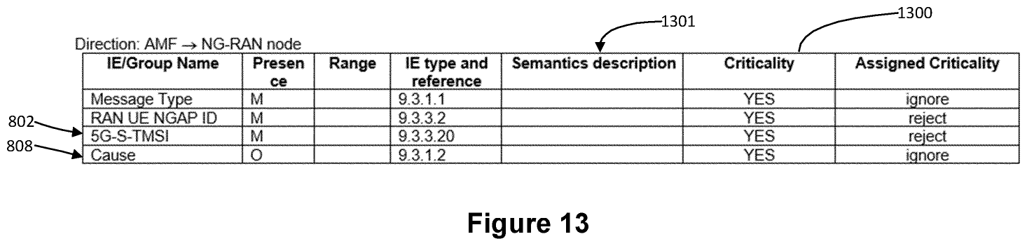

FIG. 13 is a table 1300 representing an example of contents of a SL relay paging response 1301 according to some embodiments of inventive concepts. The SL relay paging response 1301 includes a 5G-S-TSMI 802 and a cause 808 of the SL relay paging response 1301. The SL relay paging response 1301 may be used for the SL relay paging response in FIG. 11. In the example in FIG. 11, the message 1301 is sent by the AMF as a response to the request for paging a specific Sidelink Relay UE over the NG interface.

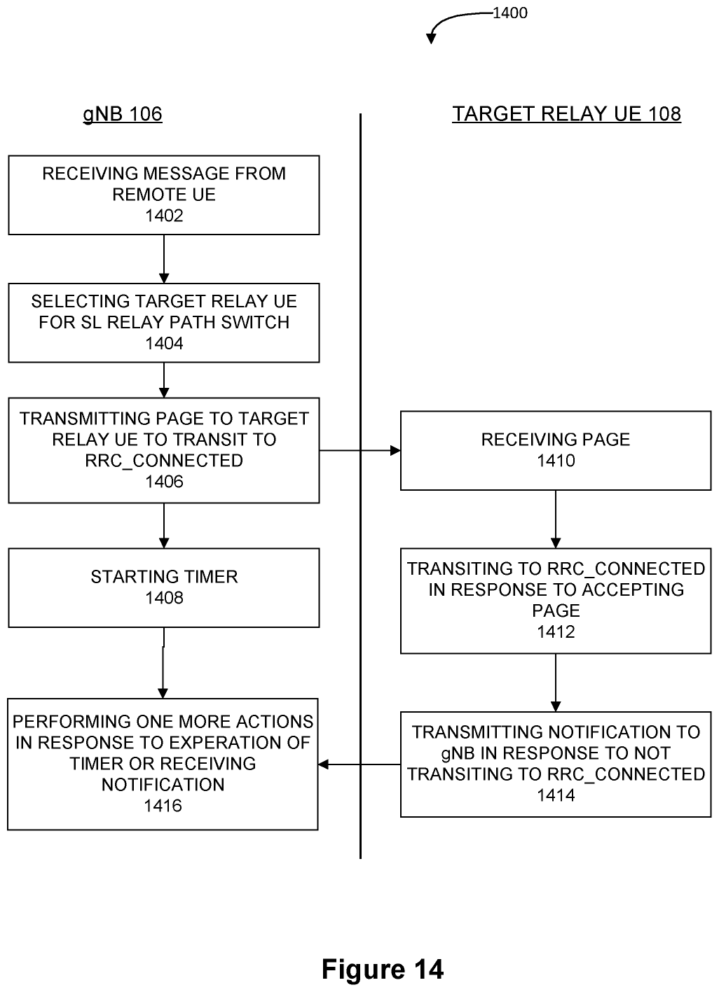

FIG. 14 is a flow chart of an example of a method 1400 for on demand paging for executing a sidelink relay path switch according to some embodiments of inventive concepts. In block 1402, the method 1400 includes receiving, by a network node, e.g., gNB 106, a message from a remote user equipment (UE). The message includes a measurement report and a list of candidate relay UEs.

In block 1404, the method 1400 includes selecting, by the network node, a target relay UE for the sidelink relay path switch from the list of candidate relay UEs. In block 1406, the method 1400 includes transmitting, by the network node, a paging request to the target relay UE. The paging request includes a request or instructions for the target relay UE to transit to a RRC_CONNECTED state for sidelink relay path switch purposes. In some examples, the paging request includes a paging cause to inform the target relay UE that the paging request is for sidelink relay path switch purposes.

In block 1408, the method 1400 includes starting a timer by the gNB 106. The network node or gNB 106 performs one or more of a set of actions in response to the target relay UE not transiting to the RRC_CONNECTED state by expiration of the timer or the target relay UE failing to transit to the RRC_CONNECTED state without starting any timer.

In block 1410, the method 1400 includes receiving the page by a target relay UE 108. In block 1412, the method 1400 includes transiting to RRC_CONNECTED by the target relay UE 108 in response to accepting the page. In some circumstances, the target relay UE 108 may skip or ignore the page or paging request. In block 1414, the method 1400 includes transmitting, by the target relay UE 108, a notification to the gNB 106 that the target relay UE 108 does not accept the page to transit to the RRC_CONNECTED state.

In block 1416, the method 1400 includes receiving, by the network node or gNB 106, a notification from the target relay UE 108 that the target relay UE 108 cannot serve as a relay UE or does not want to serve as the relay UE. In some examples, the method 1400 also includes determining by the network node that the target relay UE ignored the paging request via using a timer or another mechanism and performing one or more of a set of actions in response to receiving the notification or determining that the target relay UE ignored the paging request. In some examples, the one or more actions comprises: aborting path switch procedure and release the remote UE to RRC_IDLE or RRC_INACTIVE; selecting a new target relay UE from the list of candidate relay UEs received from the remote UE, whatever the RRC state of the relay UE in the list is; selecting a new target relay UE from the list of candidate relay UEs but only among those relay UEs which are in RRC_CONNECTED state; and sending a message to the remote UE for informing that the target relay UE is not available and that a new list of candidate relay UEs needs to be produced by the remote UE and then send to the network node.

In some examples, upon receiving a measurement report from a remote UE with a list of candidate relay UE(s), if the gNB selects as target relay UE that is in RRC_IDLE or RRC_INACTIVE, the gNB decides to page the target relay UE to indicate that the target relay UE needs to transit to RRC_CONNECTED. When paging the target relay UE, the gNB may also include a paging cause to inform the target relay UE that this paging is for sidelink relay path switch purposes.

When the gNB pages the target relay UE to indicate that the target relay UE needs to transit to RRC_CONNECTED, the gNB may also start a timer and if the relay UE does not transit to RRC_CONNECTED by the expiring of this timer, the gNB may perform at least one (or a combination) of the following actions: abort the whole path switch procedure and release the remote UE to RRC_IDLE or RRC_INACTIVE; select a new target relay UE from the list of candidate relay UEs received by the remote UE, whatever the RRC state of the relay UE in the list is; select a new target relay UE from the list of candidate relay UEs among those relay UEs which are in RRC_CONNECTED state; sends a message to the remote UE for informing that the target relay UE is not available and that a new list of candidate relay UEs needs to be produced by the remote UE (and then send to the gNB). The gNB may also perform these actions when the procedure for the relay UE to transit to RRC_CONNECTED fails (e.g, random access fails or RRC resume fails) and without necessarily starting any timer.

FIG. 15 is a flow chart of another example of a method 1500 for on demand paging for executing a sidelink relay path switch according to some embodiments of inventive concepts. In block 1502, the method 1500 includes receiving, by the network node or gNB 106, a message from a remote user equipment (UE). The message includes a measurement report and a list of candidate relay UEs.

In block 1504, the method 1500 includes selecting, by the network node, a target relay UE for the sidelink relay path switch from the list of candidate relay UEs.

In block 1506, the method 1500 includes transmitting, by the network node, a request message to the remote UE. The request message includes a request or instructions for the remote UE to establish a connection with the target relay UE and page or request the target relay UE to transit to an RRC_CONNECTED state for sidelink relay path switch purposes.

In block 1510, the method 1500 includes receiving the request message, by the remote UE 102, from a network node or gNB 106. The request message includes instructions for the remote UE to establish a connection with a target relay UE and instruct the target relay UE to transit to an RRC_CONNECTED state.

In block 1512, the method 1500 includes transmitting, by the remote UE 102, a page or instructions to the target relay UE 108 to transit to the RRC_CONNECTED state.

In block 1514, the method 1500 includes reporting to the network node or gNB 106 if the target relay UE accepted or rejected the page to transit to the RRC_CONNECTED state.

In block 1516, the method 1500 includes triggering, by the remote UE 102, a discovery procedure and/or a RRC reestablishment procedure and/or a relay re-selection procedure in response to the target relay UE 108 rejecting the page and not transiting to the RRC_CONNECTED state.

In block 1518, the method 1500 includes receiving, by the network node or gNB 106, a report from the remote UE 102 indicating whether the target relay UE accepted or rejected the page or request to transit to the RRC_CONNECTED state.

In block 1520, the network node or gNB 106 performs one or more of a set of actions in response to the target relay UE rejecting the page or request to transit to the RRC_CONNECTED state. The set of actions includes aborting path switch procedure and release the remote UE to RRC_IDLE or RRC_INACTIVE; selecting a new target relay UE from the list of candidate relay UEs received from the remote UE, whatever the RRC state of the relay UE in the list is; selecting a new target relay UE from the list of candidate relay UEs but only among those relay UEs which are in RRC_CONNECTED state; and sending a message to the remote UE for informing that the target relay UE is not available and that a new list of candidate relay UEs needs to be produced by the remote UE and then send to the network node.

In some examples, upon receiving a measurement report from a remote UE with a list of candidate relay UE(s), if the gNB selects as target relay UE that is in RRC_IDLE or RRC_INACTIVE, the gNB sends an indication, e.g., a the path switch command or an RRC reconfiguration message to the remote UE with an indication that the remote UE should establish a PC5 connection with the relay UE (if not available yet) and then the remote UE should indicate to the target relay UE that it should transit to RRC_CONNECTED.

In some examples, upon receiving the request from the gNB to establish a PC5 connection with the relay UE (if not available yet) and then indicate to the target relay UE that it should transit to RRC_CONNECTED, the remote UE reports back to the gNB if the relay UE has accepted or rejected to transit to RRC_CONNECTED. Then, when receiving this indication from the remote UE, the gNB can perform at least one (or a combination) of the following actions:
Abort the whole path switch procedure and release the remote UE to RRC_IDLE or RRC_INACTIVE. In this case the remote UE may also trigger a discovery procedure, and/or RRC reestablishment procedure, and/or a relay (re)selection procedure.
Select a new target relay UE from the list of candidate relay UEs received by the remote UE, whatever the RRC state of the relay UE in the list is.
Select a new target relay UE from the list of candidate relay UEs but only among those relay UEs which are in RRC_CONNECTED state.
Sends a message to the remote UE for informing that the target relay UE is not available and that a new list of candidate relay UEs needs to be produced by the remote UE (and then send to the gNB).

In accordance with any of the previously described embodiments, if the target relay UE decides to skip or ignore the paging (i.e., does not transit to RRC_CONNECTED because does not want to serve as a relay UE), the target relay UE may inform the gNB about this during the transit to RRC_CONNECTED (e.g., in the random access, RRC setup, or RRC resume procedure). Alternatively, the relay UE does not inform the gNB but the gNB may determine that the target relay UE skipped or ignored the paging via the use of a timer or some other mechanism. Thus, in case the target relay UE skips or ignores the paging or does not want to act as a relay UE, the gNB can perform at least one (or a combination) of the actions previously described.

In some examples, the relay UE 108 that the remote UE 102 should use is decided by the gNB 106 and communicated to the remote UE 102 via dedicated RRC signaling of system information. As another alternative, which option(s) the UE should use is decided by TX/RX UE or is pre-configured (hard-coded in the spec).

In at least some of the embodiments and examples described herein, the signaling alternatives described will include at least one of the following
For signaling between gNBs:
   X2/Xn signaling
   F1 signaling
   Inter-node RRC messages
For signaling between UE and the gNB:
   RRC signaling
   MAC CE
   L1 signaling on channels such as PRACH, PUCCH, PDCCH
   Control PDU of a protocol layer such as SDAP, PDCP, RLC or an adaptation layer which is introduced for responsible of duplication function
For signaling between UEs:
   RRC signaling (e.g., PC5-RRC)
   PC5-S signaling
   Discovery signaling
   MAC CE
   L1 signaling on channels such as PSSCH, PSCCH, or PSFCH.
   Control PDU of a protocol layer such as SDAP, PDCP, RLC or an adaptation layer which is introduced for responsible of duplication function
For signaling between the gNB and the CN and between CN entities:
   NG messages

In a further embodiment, a remote UE sends a measurement report to the gNB including, together with measurements, also a list of potential relay UE candidates selected based on certain criteria that are part of the measurement configuration. This list of potential relay UE candidates can include relay UE(s) in any RRC state, such as RRC_IDLE, RRC_INACTIVE, or RRC_CONNECTED mode. Since the gNB may use the measurements and the list of candidate relay UEs to trigger a path switch procedure, when sending the list of relay UE candidates, the remote UE may also include for each relay UE at least one of (or a combination of) the following information:

The relay UE ID used for communication on the PC5 interface (e.g., the L2 ID)

The relay UE ID used for communication on the Uu interface (e.g., RNTI or any other ID assigned by the gNB).

A mapping between the ID used by the relay UE over PC5 (e.g., the L2 ID) and the ID used by the relay UE over Uu (e.g., RNTI or any other ID assigned by the gNB).

In a further embodiment, once receiving the measurement report from the remote UE with the list of candidate relay UE, if the gNB has selected a relay UE in RRC_IDLE state as target relay UE for a path switch procedure, the gNB may perform one of (or a combination of) the following actions to instruct the relay UE to transition to RRC_CONNECTED:

The gNB initiates a signaling to the CN (e.g., by contacting the AMF), indicating the reported relay UE ID(s) in the measurement report, to either acquire the UE-TMSI value to page the relay UE or trigger the paging directly by the CN.

If the UE-TMSI is already part of the measurement report received from the remote UE, the gNB may directly page the relay UE to indicate that needs to transition to RRC_CONNECTED. To do so, it may indicate as paging cause that the paging procedure is for relay purposed or for incoming data on the remote UE.

On the other side, when the CN receives the indication from the gNB requesting to page the UE, the CN may perform one of (or a combination of) the following actions:

Provide the gNB with the UE-TMSI value or a similar UE ID for the gNB to perform the corresponding mapping/association with the reported relay UE ID and to allow the gNB to page the relay UE (to indicate the relay UE to transition to RRC_CONNECTED). The result of the mapping/association can also be a third relay UE ID which is different from the reported relay UE ID and the UE-TMSI value. With this it is assumed that the CN can achieve a mapping association between the PC5 and Uu IDs of the relay UEs. For instance, the AMF may query the vehicle-to-X (V2X) layer or the ProSe layer about what ID a relay UE is using over PC5, and vice versa. Also, certain embodiments perform this procedure every time that a relay UE is selected as target relay UE for a path switch.

The CN, if it already has a map association between all the relay UE IDs over PC5 and Uu, it sends the whole map to the gNB. The gNB will then use this to page the relay UE to indicate to transition to RRC_CONNECTED. With this, it is assumed that the CN maintains this mapping over time, for example, every time and a new relay UE is selected or used. Also, in certain embodiments, the gNB requests the mapping once and thereafter need only request a new mapping if a new relay UE (that is not in the current mapping) is selected as candidate relay UE for a path switch.

In a further embodiment, a relay UE in a CONNECTED state transmits the relay UE ID used for communication on the PC5 interface to the gNB. The gNB then performs the mapping/association between the reported relay UE ID and the assigned temporary identifier, e.g., I-RNTI or C-RNTI. The result of the mapping/association can also be a third relay UE ID that is different from the reported UE ID and the RNTI values. This is signaled to the relay UE. Certain embodiments use this only for path switch purposes.

In a further embodiment, the remote UE, upon sending a measurement report to the gNB as described in the previous embodiments, receives in response a path switch command from the gNB with a target relay UE ID in RRC_IDLE or RRC_INACTIVE state. In this case, to instruct the relay UE to perform the RRC establishment/resume/random access procedure to transition to RRC_CONNECTED, the remote UE can perform one of (or a combination of) the following actions:

The remote UE establishes a PC5 connection with the relay UE (if not yet established) and signals an indication to the target relay UE to transition to CONNECTED for sidelink relay purpose. The indication may be implicit or explicit. In case of an implicit indication, this means that a candidate relay UE should interpret any message/signaling received from the remote UE as an indication to transition to CONNECTED state, even if the message/signaling is empty.

The remote UE establishes a PC5 connection with the relay UE (if not yet established) and send a signalling over PC5 to ask the relay UE to provide one or multiple IDs that the relay UE uses for Uu operations. Once that the relay UE replies with the IDs used for Uu operations, the remote UE may send another signalling to the gNB in order to inform what the correct IDs that the network should use in order to trigger a RRC establishment/resume procedure to the correct relay UE (i.e., selected by the network for the path switch procedure).

In a further embodiment, the PC5 configuration (i.e., PC5 radio link control (RLC)/medium access control (MAC)/physical layer (PHY) setup) used in the fourth embodiment to explicitly or implicitly signal to the target relay UE can either be pre-defined/pre-configured/default configuration in the specification or embedded in the sim card (Universal Subscriber Identity Module (USIM)/Universal Integrated Circuit Card (UICC)).

In a further embodiment, the PC5 configuration used in the fourth embodiment can also include a pre-defined/pre-configured/default adaptation layer configuration and adaptation layer header.

In a further embodiment, the remote UE of the fourth embodiment, on receiving the path switch command from the gNB with a target relay UE ID in RRC_IDLE or RRC_INACTIVE state can trigger a broadcast or groupcast signal including at least the relay UE ID used for communication on the PC5 interface and/or a third relay UE ID to trigger an RRC establishment/resume/random access procedure in the target relay UE.

In addition, a network node such as gNB or a controlling UE includes a configuration for the remote UE in the RRC message sent to the relay UE (as separate information elements (IEs) or within a container), the relay UE then forwards the configuration to the remote UE using PC5-RRC. In case the container is used, the relay UE can simply put the container in its PC5-RRC without decoding it.

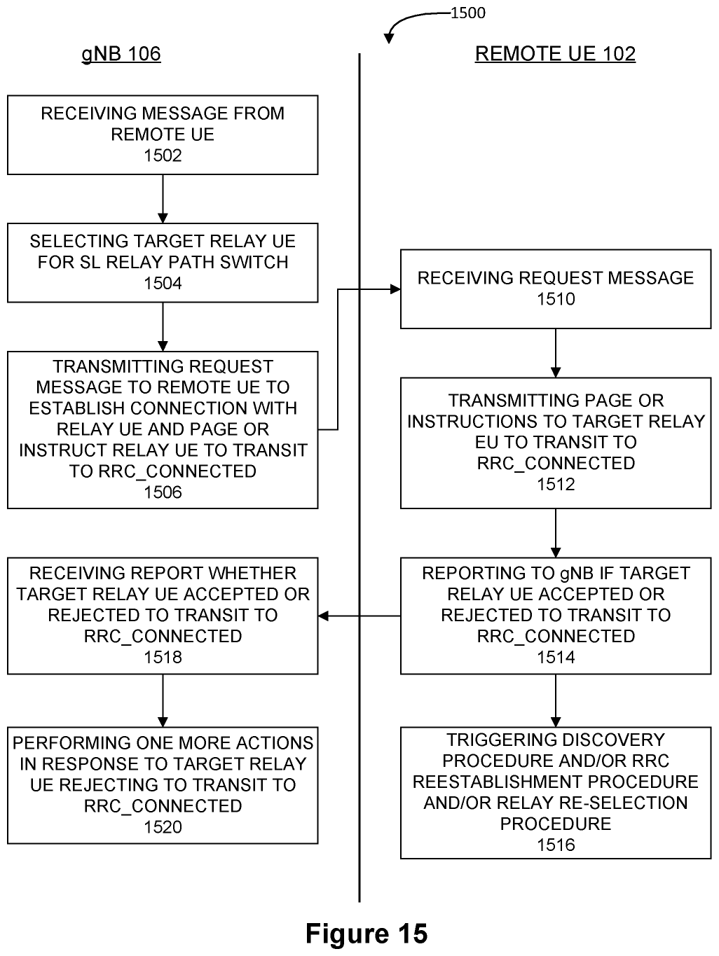

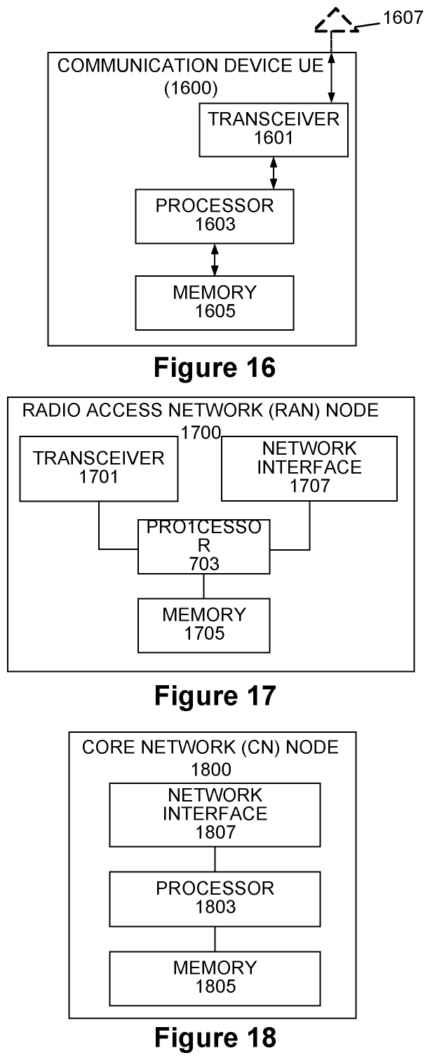

FIG. 16 is a block diagram illustrating elements of a communication device UE 1600 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. As shown, communication device UE may include an antenna 1607, and transceiver circuitry 301 (also referred to as a transceiver including a transmitter and a receiver configured to provide uplink and downlink radio communications with a base station(s) also referred to as a RAN node) of a radio access network. Communication device UE may also include processing circuitry 1603 (also referred to as a processor coupled to the transceiver circuitry, and memory circuitry 1605 (also referred to as memory coupled to the processing circuitry. The memory circuitry 1605 may include computer readable program code that when executed by the processing circuitry 1603 causes the processing circuitry to perform operations according to embodiments disclosed herein. According to other embodiments, processing circuitry 1603 may be defined to include memory so that separate memory circuitry is not required. Communication device UE may also include an interface (such as a user interface) coupled with processing circuitry 1603, and/or communication device UE may be incorporated in a vehicle.

As discussed herein, operations of communication device UE may be performed by processing circuitry 1603 and/or transceiver circuitry 1601. For example, processing circuitry 1603 may control transceiver circuitry 1601 to transmit communications through transceiver circuitry 1601 over a radio interface to a radio access network node (also referred to as a base station) and/or to receive communications through transceiver circuitry 1601 from a RAN node over a radio interface. Moreover, modules may be stored in memory circuitry 1605, and these modules may provide instructions so that when instructions of a module are executed by processing circuitry 1603, processing circuitry 1603 performs respective operations. According to some embodiments, a communication device UE 1600 and/or an element(s)/function(s) thereof may be embodied as a virtual node/nodes and/or a virtual machine/machines.

FIG. 17 is a block diagram illustrating elements of a radio access network RAN node 1700 (also referred to as a network node, base station, eNodeB/eNB, gNodeB/gNB, etc.) of a Radio Access Network (RAN) configured to provide cellular communication according to embodiments of inventive concepts. As shown, the RAN node may include transceiver circuitry 1701 (also referred to as a transceiver including a transmitter and a receiver configured to provide uplink and downlink radio communications with mobile terminals. The RAN node may include network interface circuitry 1707 (also referred to as a network interface configured to provide communications with other nodes (e.g., with other base stations) of the RAN and/or core network CN. The network node may also include processing circuitry 1703 (also referred to as a processor coupled to the transceiver circuitry, and memory circuitry 1705 (also referred to as memory coupled to the processing circuitry. The memory circuitry 1705 may include computer readable program code that when executed by the processing circuitry 1703 causes the processing circuitry to perform operations according to embodiments disclosed herein. According to other embodiments, processing circuitry 1703 may be defined to include memory so that a separate memory circuitry is not required.

As discussed herein, operations of the RAN node may be performed by processing circuitry 1703, network interface 1707, and/or transceiver 1701. For example, processing circuitry 1703 may control transceiver 1701 to transmit downlink communications through transceiver 401 over a radio interface to one or more mobile terminals UEs and/or to receive uplink communications through transceiver 1701 from one or more mobile terminals UEs over a radio interface. Similarly, processing circuitry 1703 may control network interface 407 to transmit communications through network interface 1707 to one or more other network nodes and/or to receive communications through network interface from one or more other network nodes. Moreover, modules may be stored in memory 1705, and these modules may provide instructions so that when instructions of a module are executed by processing circuitry 1703, processing circuitry 1703 performs respective operations. According to some embodiments, RAN node 1700 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 18 is a block diagram illustrating elements of a core network (CN) node (e.g., an SMF (session management function) node, an AMF (access and mobility management function) node, etc.) of a communication network configured to provide cellular communication according to embodiments of inventive concepts. As shown, the CN node may include network interface circuitry 1807 configured to provide communications with other nodes of the core network and/or the radio access network RAN. The CN node may also include a processing circuitry 1803 (also referred to as a processor,) coupled to the network interface circuitry, and memory circuitry 1805 (also referred to as memory) coupled to the processing circuitry. The memory circuitry 1805 may include computer readable program code that when executed by the processing circuitry 1803 causes the processing circuitry to perform operations according to embodiments disclosed herein. According to other embodiments, processing circuitry 1803 may be defined to include memory so that a separate memory circuitry is not required.

As discussed herein, operations of the CN node may be performed by processing circuitry 1803 and/or network interface circuitry 1807. For example, processing circuitry 1803 may control network interface circuitry 1807 to transmit communications through network interface circuitry 1807 to one or more other network nodes and/or to receive communications through network interface circuitry from one or more other network nodes. Moreover, modules may be stored in memory 505, and these modules may provide instructions so that when instructions of a module are executed by processing circuitry 503, processing circuitry 503 performs respective operations. According to some embodiments, CN node 500 and/or an element(s)/function(s) thereof may be embodied as a virtual node/nodes and/or a virtual machine/machines.

### Embodiments

### Group A Embodiments (gNB in FIG. 7)

1. A method performed by a network node (or gNB) for on demand paging for executing a sidelink relay path switch, the method comprising:
receiving, by the network node, a message from a remote user equipment (UE), wherein the message comprises a measurement report and a list of candidate relay UEs;
selecting, by the network node, a target relay UE for the sidelink relay path switch from the list of candidate relay UEs; and
transmitting, by the network node, a paging request to an entity of a core network (CN), wherein the paging request comprises instructions for the entity of the CN to page or instruct the target relay UE to transit to an RRC_CONNECTED state for sidelink relay path switch purposes.

2. The method of embodiment 1, wherein the paging request comprises at least one of: an identifications (ID) of the target relay UE;
a layer 2 (L2) ID of the target relay UE or any other ID used by the target relay UE for sidelink purposes;
an ID of the remote UE;
a L2 ID of the remote UE or any other ID used by the remote UE for sidelink purposes;
a paging cause;
a UE context ID of the target relay UE; and/or
a UE context ID of the remote UE.

3. The method of claim 2, wherein ID of the target relay UE comprises a UE-TMSI, RNTI, or any other ID useful to identify the relay UE at the CN; and wherein the ID of the remote UE comprises the UE-TMSI, RNTI, or any other ID useful to identify the remote UE at the CN).

4. The method of any of the previous embodiments, further comprising:
receiving a reply message from the entity of the CN, wherein the reply message indicates that the entity of the CN accepted the paging request to page the target relay EU or rejects the paging request; and
performing one or more of a set of actions in response to the entity of the CN rejecting the paging request.

5. The method of embodiment 4, further comprising starting a timer for the target relay to transit to the RRC_CONNECTED state before expiration of the timer in response to the reply message indicating the CN accepted the paging request.

6. The method of any of embodiments 4 or 5, wherein the set of actions comprises:
aborting path switch procedure and release the remote UE to RRC_IDLE or RRC_INACTIVE;
selecting a new target relay UE from the list of candidate relay UEs received from the remote UE, whatever the RRC state of the relay UE in the list is;
selecting a new target relay UE from the list of candidate relay UEs but only among those relay UEs which are in RRC_CONNECTED state;
sending a message to the remote UE for informing that the target relay UE is not available and that a new list of candidate relay UEs needs to be produced by the remote UE and then send to the network node; and
starting the paging (gNB-initiated paging) procedure towards the relay UE, if instructed by the CN to do so.

7. The method of any of the previous embodiments, wherein transmitting the paging request comprises transmitting an NG-AP request message with a (Serving Temporary Mobile Subscriber Identity (S-TMSI) and the paging request.

8. The method of embodiment 7, wherein the NG-AP request message comprises one of:
an existing message from Technical Standard (TS) 38.413, e.g., INITIAL UE MESSAGE;
a new class 1 (request and response) or class 2 (request only) procedure;
a S-TMSI of the target relay UE, optionally or any ID that can allow an Access & Mobility Management Function (AMF) to authenticate the request message.

### Group B Embodiments (gNB in FIG. 14)

9. A method performed by a network node (or gNB) for on demand paging for executing a sidelink relay path switch, the method comprising:
receiving, by the network node, a message from a remote user equipment (UE), wherein the message comprises a measurement report and a list of candidate relay UEs;
selecting, by the network node, a target relay UE for the sidelink relay path switch from the list of candidate relay UEs; and
transmitting, by the network node, a paging request to the target relay UE, wherein the paging request comprises a request or instructions for the target relay UE to transit to an RRC_CONNECTED state for sidelink relay path switch purposes.

10. The method of embodiment 9, wherein the paging request comprises a paging cause to inform the target relay UE that the paging request is for sidelink relay path switch purposes.

11. The method of embodiment 9, further comprising starting a timer, wherein the network node performs one or more of a set of actions in response to the target relay UE not transiting to the RRC_CONNECTED state by expiration of the timer or the target relay UE failing to transit to the RRC_CONNECTED state without starting any timer.

12. The method of embodiment 9, further comprising:
receiving a notification from the target relay UE that the target relay UE cannot serve as the relay UE or does not want to serve as the relay UE; or
determining by the network node that the target relay UE ignored the paging request via using a timer or another mechanism; and
performing one or more of a set of actions in response to receiving the notification or determining that the target relay UE ignored the paging request.

13. The method of any of embodiments 11 or 12, wherein the one or more actions comprises: wherein the set of actions comprises:
aborting path switch procedure and release the remote UE to RRC_IDLE or RRC_INACTIVE;
selecting a new target relay UE from the list of candidate relay UEs received from the remote UE, whatever the RRC state of the relay UE in the list is;

selecting a new target relay UE from the list of candidate relay UEs but only among those relay UEs which are in RRC_CONNECTED state; and
sending a message to the remote UE for informing that the target relay UE is not available and that a new list of candidate relay UEs needs to be produced by the remote UE and then send to the network node.

### Group C Embodiments (gNB in FIG. 15)

14. A method performed by a network node (or gNB) for on demand paging for executing a sidelink relay path switch, the method comprising:
receiving, by the network node, a message from a remote user equipment (UE), wherein the message comprises a measurement report and a list of candidate relay UEs;
selecting, by the network node, a target relay UE for the sidelink relay path switch from the list of candidate relay UEs; and
transmitting, by the network node, a request message to the remote UE, wherein the request message comprises a request or instructions for the remote UE to establish a connection with the target relay UE and page or request the target relay UE to transit to an RRC_CONNECTED state for sidelink relay path switch purposes.

15. The method of embodiment 13, further comprising receiving a report from the remote UE indicating whether the target relay UE accepted or rejected the page or request to transit to the RRC_CONNECTED state.

16. The method of embodiment 14, wherein the network node performs one or more of a set of actions in response to the target relay UE rejecting the page or request to transit to the RRC_CONNECTED state.

17. The method of embodiment 15, wherein the one or more actions comprises: wherein the set of actions comprises:
aborting path switch procedure and release the remote UE to RRC_IDLE or RRC_INACTIVE;
selecting a new target relay UE from the list of candidate relay UEs received from the remote UE, whatever the RRC state of the relay UE in the list is;
selecting a new target relay UE from the list of candidate relay UEs but only among those relay UEs which are in RRC_CONNECTED state; and
sending a message to the remote UE for informing that the target relay UE is not available and that a new list of candidate relay UEs needs to be produced by the remote UE and then send to the network node.

### Group D Embodiments (CN (AMF) in FIG. 7)

18. A method performed by a network node (CN (AMF)) for on demand paging for executing a sidelink relay path switch, the method comprising:
receiving, by the network node, a paging request from another network node (gNB) for paging a target relay UE for sidelink relay path switch purposes;
transmitting, by the network node, a reply message to the other network node, wherein the reply message comprises an acceptance or rejection to the paging request for paging the target relay UE; and
performing a paging procedure in response to accepting the paging request.

19. The method of embodiment 18, wherein performing the paging procedure comprises transmitting a paging message to the target relay UE, wherein the paging message comprises a paging cause to indicate to the target relay UE that the paging message is for sidelink relay path switch purposes.

20. The method of any of the previous embodiments, further comprising transmitting a message to the other network node that the paging message has been transmitted to the target relay UE so the other network node may start a timer so that until the timer expires the target relay UE did not transit to an RRC_CONNECTED state, the other network node understands that the target relay is not willing to accommodate a remote UE and the other network node may perform further actions.

21. The method of embodiment 18, wherein the paging request comprises at least one of:
an identifications (ID) of the target relay UE;
a layer 2 (L2) ID of the target relay UE or any other ID used by the target relay UE for sidelink purposes;
an ID of the remote UE;
a L2 ID of the remote UE or any other ID used by the remote UE for sidelink purposes;
a paging cause;
a UE context ID of the target relay UE; and/or
a UE context ID of the remote UE.

### Group E Embodiments (Target Relay UE in FIG. 14)

22. A method performed by a user equipment (a target relay UE) for on demand paging for executing a sidelink relay path switch, the method comprising:
receiving a page from a network node (gNB), wherein the page comprises an indication that the user equipment needs to transit to an RRC_CONNECTED state;
transiting to the RRC_CONNECTED state in response to accepting the page; and
transmitting a notification to the network node in response to not transiting to the RRC_CONNECTED state.

### Group E Embodiments (Remote UE in FIG. 15)

23. A method performed by a user equipment (a remote UE) for on demand paging for executing a sidelink relay path switch, the method comprising:
receiving a request message from a network node (gNB), wherein the request message comprises an instructions that the user equipment for the user equipment to establish a connection with a target relay UE and instruct the target relay UE to transit to an RRC_CONNECTED state;
transmitting a page to the target relay UE to transit to the RRC_CONNECTED state; and
reporting to the network node if the target relay UE accepted or rejected the page to transit to the RRC_CONNECTED state.

24. The method of embodiment 23, further comprising triggering a discovery procedure and/or a RRC reestablishment procedure and/or a relay re-selection procedure in response to the target UE rejecting the page and not transiting to the RRC_CONNECTED state.

Group F embodiments

25. The method of any of Group A-E embodiments, wherein signaling between network nodes (gNBs) comprises at least one of X2/Xn signaling, F1 signaling, and/or inter-node RRC messages.

26. The method of any of Group A-E embodiments, wherein signaling between any of the UEs and the network node (gNB) comprises at least one of RRC signaling, MAC CE, L1 signaling on channels such as PRACH, PUCCH, PDCCH, and/or control PDU of a protocol layer such as SDAP, PDCP, RLC or an adaptation layer which is introduced for responsible of duplication function.

27. The method of any of Group A-E embodiments, wherein signaling between UEs (remoter US and target relay UE) comprises RRC signaling (e.g., PC5-RRC), PC5-S signaling, Discovery signaling, MAC CE, L1 signaling on channels such as PSSCH, PSCCH, or PSFCH, and/or Control PDU of a protocol layer such as SDAP, PDCP, RLC or an adaptation layer which is introduced for responsible of duplication function.

28. The method of any of Group A-E embodiments, wherein signaling between the gNB and the CN and between CN entities comprises NG messages.

Group G Embodiments

29. A user equipment for on demand paging for executing a sidelink relay path switch, the user equipment comprising:
processing circuitry configured to perform any of the steps of any of the Group E and Group F embodiments; and
power supply circuitry configured to supply power to the processing circuitry.

30. A network node for on demand paging for executing a sidelink relay path switch, the network node comprising:
processing circuitry configured to perform any of the steps of any of Groups A-D embodiments; and
power supply circuitry configured to supply power to the processing circuitry.

### Further Embodiments

A1. A method performed by a remote user equipment (UE), the method comprising:
performing measurements of one or more relay UE candidates, each relay UE candidate a candidate to communicate with the remote UE via sidelink communication to facilitate relaying data between the remote UE and a network node; and
sending the network node a list of the relay UE candidates.

A2. The method of embodiment A1, wherein the list of the relay UE candidates is sent in a measurement report.

A3. The method of any of embodiments A1-A2, wherein the list of relay UE candidates comprises at least one relay UE candidate in an idle state.

A4. The method of any of embodiments A1-A3, wherein the list of relay UE candidates comprises at least one relay UE candidate in an inactive state.

A5. The method of any of embodiments A1-A4, wherein the list of relay UE candidates comprises at least one relay UE candidate in a connected state.

A6. The method of any of embodiments A1-A5, wherein the list of the relay UE candidates comprises, for each relay UE candidate, a first identifier configured to identify the relay UE candidate with respect to the sidelink communication.

A7. The method of embodiment A6, wherein the first identifier comprises a layer 2 identifier (L2 ID).

A8. The method of any of embodiments A1-A7, wherein the sidelink communication comprises communication via a PC5 interface.

A9. The method of any of embodiments A1-A8, wherein the list of the relay UE candidates comprises, for each relay UE candidate, a second identifier configured to identify the relay UE candidate with respect to communication with a radio access network or core network.

A10. The method of embodiment A9, wherein the second identifier comprises a temporary mobile subscriber identity (TMSI).

A11. The method of embodiment A9, wherein the second identifier comprises a radio network temporary identifier (RNTI).

A12. The method of any of embodiments A1-A11, wherein the communication with the radio access network or core network comprises communication via a Uu interface.

A13. The method of any of embodiments Al-A12, wherein the list of the relay UE candidates comprises a mapping between a first identifier and a second identifier, the first identifier configured to identify the relay UE candidate with respect to the sidelink communication and the second identifier configured to identify the relay UE candidate with respect to communication with a radio access network or core network.

A14. The method of any of embodiments A1-A13, further comprising:
receiving a path switch command from the network node, the path switch command comprising an identifier associated with a target relay UE, the target relay UE corresponding to one of the relay UE candidates in idle state or inactive state; and
instructing the target relay UE to perform a connection establishment procedure, a connection resume procedure, or an access procedure to transition to a connected state.

A15. The method of any of the previous embodiments, further comprising:
providing user data; and
forwarding the user data to a host via the transmission to the network node.

B1. A method performed by a radio access network node (e.g., a base station, such as a gNB), the method comprising:
determining a mapping between a first identifier associated with a relay user equipment (UE) and a second identifier associated with the relay UE, the first identifier configured to identify the relay UE with respect to sidelink communication to a remote UE, the second identifier configured to identify the relay UE with respect to communication with a radio access network or core network; and
using the mapping to facilitate communication with the relay UE.

B2. The method of embodiment B1, wherein the first identifier comprises a layer 2 identifier (L2 ID).

B3. The method of embodiment B1 or B2, wherein the second identifier comprises a temporary mobile subscriber identity (TMSI).

B4. The method of embodiment B1 or B2, wherein the second identifier comprises a radio network temporary identifier (RNTI).

B5. The method of any of embodiments B1-B4, further comprising:
determining that the relay UE is in an idle state or an inactive state;
wherein, based on determining that the relay UE is in an idle state or an inactive state, using the mapping to facilitate communication with the relay UE comprises initiating sending a page to the relay UE, the page indicating to transition to a connected state, the page comprising at least one of the first identifier or the second identifier.

B6. The method of embodiment B5, wherein the page is sent from the radio access network node (e.g., base station) to the relay UE.

B7. The method of embodiment B5, wherein initiating the sending of the page comprises requesting the core network (CN) to page the relay UE.

B8. The method of any of embodiments B1-B7, further comprising:
determining the relay UE is in a connected state; and
sending data to the remote UE via the relay UE in the connected state.

B9. The method of any of embodiments B1-B8, further comprising:
receiving an indication from the relay UE indicating that the remote UE has data to transmit.

B10. The method of embodiment B9, wherein the relay UE indicates that the remote UE has data to transmit by initiating an access procedure, a procedure for establishing a connection, or a procedure for resuming the connection.

B11. The method of any of embodiments B1-B10, further comprising:
receiving a measurement report from the remote UE with a list of candidate relay UEs; and
selecting the relay UE from the list of candidate relay UEs.

B12. The method of any of embodiments B1-B11, further comprising obtaining the first identifier from the relay UE.

B13. The method of any of embodiments B1-B12, wherein determining the mapping comprises:
receiving the mapping from the remote UE;
receiving the mapping from the relay UE;
receiving the mapping from the CN; or
generating the mapping at the radio access network node.

B14. A method performed by a core network, the method comprising:
receiving, from a radio access network node (e.g., a base station, such as a gNB), a request to page a relay UE; and
providing the radio access network node with a mapping or with information that enables the radio access network node to determine the mapping, wherein the mapping maps a first identifier associated with the relay UE and a second identifier associated with the relay UE, the first identifier configured to identify the relay UE with respect to sidelink communication to a remote UE, the second identifier configured to identify the relay UE with respect to communication with a radio access network or the core network.

B15. The method of embodiment B14, wherein the first identifier comprises a layer 2 identifier (L2 ID).

B16. The method of any of embodiments B14-B15, wherein the second identifier comprises a temporary mobile subscriber identity (TMSI) or a radio network temporary identifier (RNTI).

B17. The method of any of embodiments B1-B16, wherein the sidelink communication comprises communication via a PC5 interface and wherein the communication with the radio access network or the core network comprises communication via a Uu interface.

B18. The method of any of the previous embodiments, further comprising:
obtaining user data; and
forwarding the user data to a host or a user equipment.

C1. A user equipment, comprising:
processing circuitry configured to perform the steps of any of above-described UE methods; and
power supply circuitry configured to supply power to the processing circuitry.

C2. A network node, the network node comprising:
processing circuitry configured to perform the steps of any of above-described network node methods;
power supply circuitry configured to supply power to the processing circuitry.

C3. A user equipment (UE), the UE comprising:
an antenna configured to send and receive wireless signals; radio front-end circuitry connected to the antenna and to processing circuitry, and configured to condition signals communicated between the antenna and the processing circuitry;
the processing circuitry being configured to perform any of the steps of any of above-described UE methods;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C4. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of above-described UE methods to receive the user data from the host.

C5. The host of the previous embodiment, wherein the cellular network further includes a network node configured to communicate with the UE to transmit the user data to the UE from the host.

C6. The host of the previous 2 embodiments, wherein:
the processing circuitry of the host is configured to execute a host application, thereby providing the user data; and
the host application is configured to interact with a client application executing on the UE, the client application being associated with the host application.

C7. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of above-described UE methods to receive the user data from the host.

C8. The method of the previous embodiment, further comprising:
at the host, executing a host application associated with a client application executing on the UE to receive the user data from the UE.

C9. The method of the previous embodiment, further comprising:
at the host, transmitting input data to the client application executing on the UE, the input data being provided by executing the host application,
wherein the user data is provided by the client application in response to the input data from the host application.

C10. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of above-described UE methods to transmit the user data to the host.

C11. The host of the previous embodiment, wherein the cellular network further includes a network node configured to communicate with the UE to transmit the user data from the UE to the host.

C12. The host of the previous 2 embodiments, wherein:
the processing circuitry of the host is configured to execute a host application, thereby providing the user data; and
the host application is configured to interact with a client application executing on the UE, the client application being associated with the host application.

C13. A method implemented by a host configured to operate in a communication system that further includes a network node and a user equipment (UE), the method comprising:
at the host, receiving user data transmitted to the host via the network node by the UE, wherein the UE performs any of the steps of any of above-described UE methods to transmit the user data to the host.

C14. The method of the previous embodiment, further comprising:
at the host, executing a host application associated with a client application executing on the UE to receive the user data from the UE.

C15. The method of the previous embodiment, further comprising:
at the host, transmitting input data to the client application executing on the UE, the input data being provided by executing the host application,
wherein the user data is provided by the client application in response to the input data from the host application.

C16. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of above-described network node methods to transmit the user data from the host to the UE.

C17. The host of the previous embodiment, wherein:
the processing circuitry of the host is configured to execute a host application that provides the user data; and
the UE comprises processing circuitry configured to execute a client application associated with the host application to receive the transmission of user data from the host.

C18. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations the steps of any of above-described network node methods to transmit the user data from the host to the UE.

C19. The method of the previous embodiment, further comprising, at the network node, transmitting the user data provided by the host for the UE.

C20. The method of any of the previous 2 embodiments, wherein the user data is provided at the host by executing a host application that interacts with a client application executing on the UE, the client application being associated with the host application.

C21. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of above-described network node methods to transmit the user data from the host to the UE.

C22. The communication system of the previous embodiment, further comprising:
the network node; and/or
the user equipment.

C23. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of above-described network node methods to receive the user data from a user equipment (UE) for the host.

C24. The host of the previous 2 embodiments, wherein:
the processing circuitry of the host is configured to execute a host application, thereby providing the user data; and
the host application is configured to interact with a client application executing on the UE, the client application being associated with the host application.

C25. The host of the any of the previous 2 embodiments, wherein the initiating receipt of the user data comprises requesting the user data.

C26. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of above-described network node methods to receive the user data from the UE for the host.

C27. The method of the previous embodiment, further comprising at the network node, transmitting the received user data to the host.

1.-26. (canceled)

27. A method performed by a network node for on demand paging for executing a sidelink relay path switch, the method comprising:
receiving, by the network node, a message from a remote user equipment, UE, wherein the message comprises a measurement report and a list of candidate relay UEs;
selecting, by the network node, a target relay UE for the sidelink relay path switch from the list of candidate relay UEs; and
transmitting, by the network node, a request message to the remote UE, wherein the request message comprises a request or instructions for the remote UE to establish a connection with the target relay UE and page or request the target relay UE to transit to an RRC_CONNECTED state for sidelink relay path switch purposes.

28. The method of claim 27, further comprising receiving a report from the remote UE indicating whether the target relay UE accepted or rejected the page or request to transit to the RRC_CONNECTED state.

29. The method of claim 27, wherein the network node performs one or more actions in response to the target relay UE rejecting the page or request to transit to the RRC_CONNECTED state.

30. The method of claim 29, wherein the one or more actions comprises:
aborting path switch procedure and release the remote UE to RRC_IDLE or RRC_INACTIVE;
selecting a new target relay UE from the list of candidate relay UEs received from the remote UE, whatever the RRC state of the relay UE in the list is;
selecting a new target relay UE from the list of candidate relay UEs but only among those relay UEs which are in RRC_CONNECTED state; and
sending a message to the remote UE for informing that the target relay UE is not available and that a new list of candidate relay UEs needs to be produced by the remote UE and then send to the network node.

31. A method performed by a user equipment, remote UE, for on demand paging for executing a sidelink relay path switch, the method comprising:
receiving a request message from a network node, comprising to establish a connection with a target relay UE;
transmitting an instruction to the target relay UE to transit to the RRC_CONNECTED state; and
reporting to the network node if the target relay UE accepted or rejected the page to transit to the RRC_CONNECTED state.

32. The method of claim 31, further comprising triggering a discovery procedure and/or a RRC reestablishment procedure and/or a relay re-selection procedure in response to the target UE rejecting the page and not transiting to the RRC_CONNECTED state.

33. The method of claim 31, further comprising: performing measurements of one or more relay UE candidates, each relay UE candidate being a candidate to communicate with the remote UE via sidelink communication; and
sending to the network node a measurement report comprising a list of the relay UE candidates.

34. The method of claim 31, further comprising at least one of:
the signaling between network nodes comprises at least one of X2/Xn signaling, F1 signaling, and/or inter-node RRC messages;
the signaling between any of the UEs and the network node comprises at least one of RRC signaling, MAC CE, L1 signaling on channels such as PRACH, PUCCH, PDCCH, and/or control PDU of a protocol layer such as SDAP, PDCP, RLC or an adaptation layer which is introduced for responsible of duplication function;
the signaling between UEs comprises PC5-RRC signaling, PC5-S signaling, Discovery signaling, MAC CE, L1 signaling on channels such as PSSCH, PSCCH, or PSFCH, and/or Control PDU of a protocol layer such as SDAP, PDCP, RLC or an adaptation layer which is introduced for responsible of duplication function; and
the signaling between the gNB and the CN and between CN entities comprises NG messages.

35. A user equipment for on demand paging for executing a sidelink relay path switch, the user equipment comprising:
processing circuitry configured to perform the steps of:
receiving a request message from a network node, comprising to establish a connection with a target relay UE;
transmitting an instruction to the target relay UE to transit to the RRC_CONNECTED state; and
reporting to the network node if the target relay UE accepted or rejected the page to transit to the RRC_CONNECTED state.

36. A network node for on demand paging for executing a sidelink relay path switch, the network node comprising:
processing circuitry configured to perform the steps of:
receiving, a message from a remote user equipment, UE, wherein the message comprises a measurement report and a list of candidate relay UEs;
selecting a target relay UE for the sidelink relay path switch from the list of candidate relay UEs; and
transmitting a request message to the remote UE, wherein the request message comprises a request or instructions for the remote UE to establish a connection with the target relay UE and page or request the target relay UE to transit to an RRC_CONNECTED state for sidelink relay path switch purposes.
